(19) United States
(12) Patent Application Publication
(10) Pub. No.: US 2007/0033752 A1
(43) Pub. Date: Feb. 15, 2007

(54) Dryer duct & drain cleaning device

(76) Inventor: Yoen Hung, Renton, WA (US)

Correspondence Address: WOOD AND EISENBERG, PLLC, 2121 Eisenhower Ave, Suite 200, Alexandria, VA, 22314, US

(21) Appl. No.: 11/202,837

(22) Filed: Aug. 12, 2005

(51) Int. Cl. B08B 3/00; B08B 9/00

(52) U.S. Cl. 15/104.2; 134/166 C; 134/166 R; 15/104.095; 15/104.33

(57) ABSTRACT

A dryer duct cleaning apparatus and method for cleaning and maintaining the interior of most types of dryer ducts, including clothing dryer ducts and related vents. The apparatus is made up of a flexible coil connected to a rotating device at one end and a cleaning brush or accessory at the other. The flexible coil can be extended through the use of attached housing to create a set length cleaning apparatus. The cleaning brushes configured in a variety of sizes with differing configurations of bristled appendages for specific applications.

### CROSS-REFERENCE TO RELATED APPLICATION

### STATEMENT REGARDING FEDERALLY SPONSORED RESEARCH OR DEVELOPMENT

Not applicable

### REFERENCE TO SEQUENCE LISTING

Not applicable

### FIELD OF THE INVENTION

This invention relates generally to the cleaning of ducting and more particularly to an apparatus and method for cleaning dryer ducting that uses specifically configured brush in conjunction with a flexible coil with capability to clean drains by changing accessory.

### BACKGROUND OF THE INVENTION

Dryer Duct Cleaner is hand held and can be freestanding battery or electric operated device that consists of an outer drum and an inner rotating drum and the cable. A rotating inner drum having a drum axis, one end of the inner drum fit to the inside of the outer drum for support, The other end having a drive rod through the other side of the outer drum to use by the battery or electric drill.

The standard dryer duct is 4 inches in diameter although some are as small as 2 inches, some being rigid and some flexible. If the laundry room away from an exterior wall than the duct line will be longer and more likely to be subject to lint clogs which can shorten the life of the dryer, cause fires and increase utility costs..

The size of the coil can be change from ¼″ to ½″ and the length can be up to 50 feet.

The outer drum is attached with strap on both sides. This strap is use around the neck or shoulder to lower the weight and balance when both hands in use with the device. The flexible cable storages in the inner drum, having an end from drum extending into the duct to be cleaned. The inner drum contains the coil which is extended up to 50 feet during use. The coil can change from ¼ inch to ½ inch.

When operating this device, one hand holding the battery or electric drill, and the drill is attached to the rod where the rod is fastened in the inner drum through the outer drum. And other hand is holding the handle the handle is fastened or molding in the center of the outer drum, where the cable is passing through the handle for forward and retrieve through inside the handle.

To use, by placing the cable into the duct keep stretching until the obstacle meet then stop feeding. Turn the drill to forward or reverse position; this will drive the inner drum in rotation and then the inner drum will turn the cable into rotation motion this will release or soften the obstacle, retrieving the cable will removed the lint.

Devices having a shaft connected to a body configured with cleaning elements have long been used for cleaning internal tubes, ducts and chimneys. These devices are typically rotated as they are moved inside the tube, duct, or chimney, to be cleaned. However, differing types and uses of ducts have made these devices less desirable and in some situations unusable.

For example, recent advances in air conditioning and heating ducting, as well as other ducting systems, have led to the use of smaller diameter ducting as well as ducting with a thinner wall thickness. Since these ducts have smaller passageways than previous ducting, there is an increase in the chance of dirt and dust buildup, as well as an increased chance of becoming blocked. Further, since these ducts have thinner walls and are thus typically weaker, older cleaning devices may actually damage the ducts rather than clean. Thus, there is a need for a cleaning apparatus and method for cleaning and maintaining ducts, as well as for locating blockages that is not damaging.

As another example, modern dryers use plastics instead of the traditional steel ducts. This is particularly true for the smaller dryers designed for apartments and small homes. These ducts are often smaller in diameter than the traditional dryers and may have a number of bends which may be more susceptible to dangerous clogging and resin buildup. The use of traditional tools often does not work in the smaller ducts and can damage the thin walls of the ducting. Thus, there is a need for a cleaning apparatus and method for cleaning ducts of a plastic nature.

An additional problem encountered in chimney ducts as well as in air conditioning, heating and other ducting, occurs when two ducts of differing diameter meet. Previous duct cleaning tools were not very effective or required cleaning the duct from both ends and using two different size cleaning heads. This was particularly true if the difference in ducting diameters was more than slight. Additionally, cleaning from both ends is not always possible. Thus, there is a need for a duct cleaning apparatus and method for cleaning ducting that has different diameters.

Existing duct cleaning devices include cleaning tools which have wire brush ends. A problem with these wire brushes generally occurs at the brush ends and particularly, when used in larger diameter duct applications. For example, the shafts of the brush wires must be stiff enough to create a brush effective for cleaning, but not so stiff that the wires damage the duct. Larger diameter ducts require a stiffer wire shaft to support the bristles out at the walls of the duct. However, these stiffer shafts mean larger diameter wires which are less flexible and tend to damage the ducts. Also, differing applications may call for different brush stiffness in a similar duct diameter. Thus, there is a need for a duct cleaning tool that can provide differing brush stiffness at the walls of similar diameter ducts.

Additionally, a recent increase in the use of ducts has lead to an increased need for duct cleaning and maintenance tools and methods. For example, modern dryer ducts or vent systems can trap lint and become a fire hazard. Stoves and furnace ducts or vents may have similar problems. All of these ducts may potentially become clogged by lint, dirt, animal waste or nests. These clogs must be located and then cleaned out.

What is needed therefore is a duct cleaning apparatus and method that can clean and maintain modem ducts and ducting systems without causing damage. This duct cleaning apparatus and method should be able to locate and clean out blockages as well as effectively clean a continuous duct of two differing diameters. The ducting cleaning apparatus and method should be relatively simple to use and inexpensive.

This Dryer Duct Cleaner device is generating rotation motion by the powered drill or manual crank causing the rotation to the inner drum then to the cable for clearing the lint builds up with moisture in the duct.

This device is manually fed into the dryer duct until the blocked by the obstacles then one hand holding the drill in forward or reverse direction while the other hand is keep stretching and pulling until the obstacle is cleared.

After the lint is removed, the dryer will use less energy and the clothes will dry faster. This device will replace the wound cable by itself. The improvement of this is when feeding to the elbow the powered drill will rotate the cable enable the cable have more turn to searching for opening access.

The present invention satisfies the need for a duct cleaning apparatus and method that effectively cleans and maintains the interior of ducting without causing damage.

The present invention is generally directed to an apparatus and method for cleaning and maintaining dryer ducts. In one broad aspect, a dryer duct cleaning apparatus is provided comprising a flexible coil which has a first end, a second end and an axis. The first end of the shaft is fitted with an attachment designed for a hand held power screwdriver.

A base or housing is also provided which has an upper end and a lower end. The lower end of the base is fitted with a stand for level placement. The base or housing contains the flexible coil wound on an axis for easy access and deployment.

At least a portion of the cleaning apparatus is made from a plurality of wires or other bristles which have ends that are spread out and exposed at the distal ends. These exposed individual wires or bristles form a bristled end for contact with the inner walls of the duct to be cleaned and maintained.

Methods for making a flexible coil assembly for use with duct cleaning and maintenance tools, for example the presently described apparatus, are included within the scope of the present invention. In general, such methods comprise providing a flexible coil which has a proximal end and a distal end.

The invention, together with additional features and advantages thereof, may be best understood by reference to the following description taken in conjunction with the accompanying illustrative drawings.

Accordingly, it is among the objects of the present invention to provide a novel article and bookmark device which is compact, simple to manufacturer, and economical in cost. Another objective of the present invention is to provide a holder which may be releasibly attached to the cover of a book or other surface. Still another objective is to provide a holder for accommodating a plurality of articles of varied dimensions.

### SUMMARY OF THE INVENTION

The device I have invented is a newly designed handheld and freestanding tool for dryer duct cleaning and drain cleaning.

This cable-feeding device is to use for clearing the lint or obstacle from the dryer duct or drain

After the lint is removed the dryer will use less energy and the clothes will dry faster. One object of the present invention is to provide dryer duct cleaner, which provides an easy economical way to clean a dryer duct lining.

It is an objective of the invention to provide a dryer duct cleaner which is relatively easier to use and more accurate than existing tools.

Another object of the invention is to provide a dryer duct cleaner that can also be used as a drain cleaning device.

It is another objective to provide dryer duct cleaner which is unitary in content and does not require additional tools other than a hand held drill.

It is a further object of the invention to provide dryer duct cleaner which is designed to be efficient and easy to use.

It is yet a further object of the invention to provide a dryer duct cleaner which is inexpensive and easy to manufacture.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a dryer duct cleaner and method which has many of the advantages of the cleaning tools mentioned heretofore and many novel features that result in a dryer duct cleaner which is not anticipated, rendered obvious, suggested, or even implied by any of the prior art tools, either alone or in any combination thereof.

It is another object of the present invention to provide dryer duct cleaner which may be easily and efficiently manufactured and marketed.

It is a further object of the present invention to provide dryer duct cleaner device which is of a durable and reliable construction.

An even further object of the present invention is to provide a dryer duct cleaner which is susceptible of a low cost of manufacture with regard to both materials and labor, and which accordingly is then susceptible of low prices of sale to the consuming public, thereby making such a device economically available to the buying public.

Still yet another object of the present invention is to provide a dryer duct cleaner which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

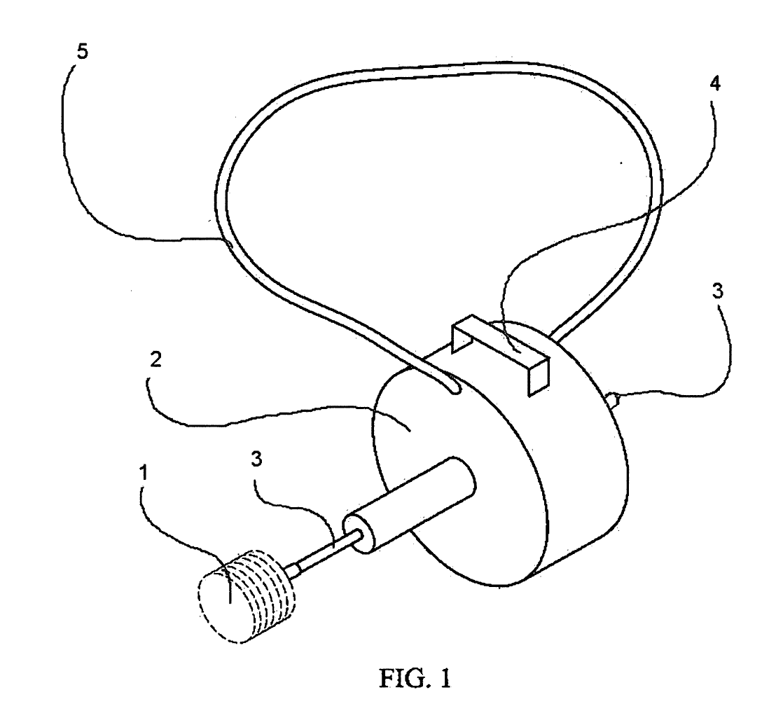

In reference to the illustrations, now referring to FIG. 1, numeral 1 represents the device accessory which is attached to, and rotates in use on 3, the device coil contained within the housing 2. Attached to the outer housing is the carrying handle 4 and the shoulder strap 5. The manual crank for the coil rotation is completed with the attachment handle 6.

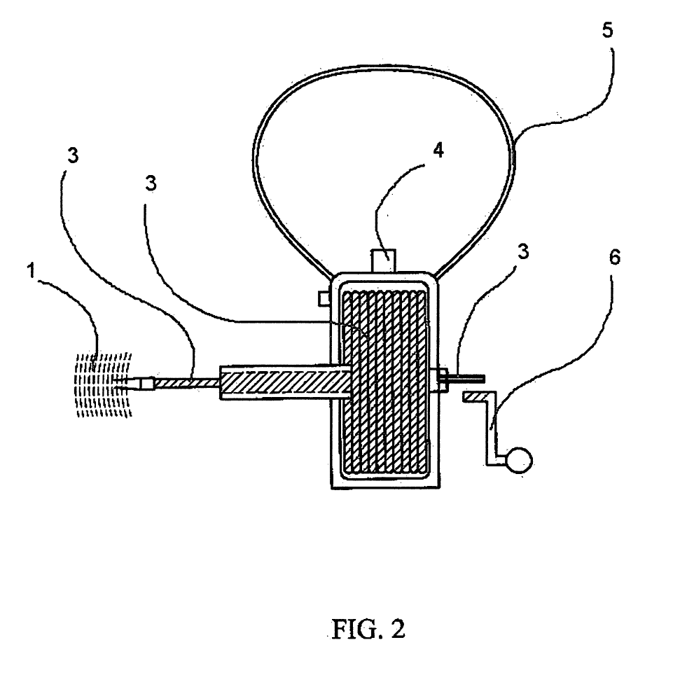

In reference to FIG. 2, the coil attachment 1 is attached to the end of the rotation coil 3 as indicated throughout the illustration. The shoulder strap 5 and handle 4 can be used to carry the device while in our out of use.

I claim:

1. A self contained, free standing dryer duct & drain cleaning device having an outer drum with an inner axis mounted drum with coil containment.

2. A dryer duct & drain cleaning device according to claim 1 wherein the device coil can be rotated electronically or manually.

3. A dryer duct & drain cleaning device according to claim 1 wherein the device coil can be change length from ¼ ″to ½″ in diameter and the length can be up to 50 feet.

4. A dryer duct & drain cleaning device according to claim 1 wherein the device can be used for dryer ventilation and plumbing lines.

5. A dryer duct & drain cleaning device according to claim 1 wherein the device has a neck and shoulder strap for easy carrying and use.

6. A dryer duct & drain cleaning device according to claim 1 wherein the device has a variety of point of contact end attachments.
